(19) United States
(12) Patent Application Publication
(10) Pub. No.: US 2005/0249233 A1
(43) Pub. Date: Nov. 10, 2005

(54) Method for making effective use of bandwidth in multicast communication on ring network

(75) Inventors: Yuuichi Akaba, Kawasaki (JP); Emiko Kobayashi, Kawasaki (JP); Hiroyuki Murakami, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki-shi (JP)

(21) Appl. No.: 11/050,688

(22) Filed: Feb. 7, 2005

Related U.S. Application Data
(63) Continuation of application No. PCT/JP03/00274, filed on Jan. 15, 2003.

(51) Int. Cl. H04L 12/28

(52) U.S. Cl. 370/432

(57) ABSTRACT

In a ring network, a sending host and a receiving node performing multi-cast communication share entry information indicating the node related to the he multi-cast communication. Moreover, the sending node and the receiving node broadcast the entry information on the ring network and share topology information related to a positional relationship on the ring network. Moreover, the sending node references the entry information and the topology information so as to determine the sending direction of the information to be multicast and transmits the information by multicast in the transmission direction. Furthermore, the aforementioned receiving node discards the information when no other receiving node receiving the information in present in the transmission direction.

### BACKGROUND OF THE INVENTION

The present invention relates to a technique for effectively using bandwidth in multicast packet communication on a ring-type IP network.

In general, ring networks using optical fibers are in wide use to transmit large amounts of data, such as image data, with ensured economical efficiency and reliability.

Protocols for optical fiber ring networks for SONET include the RPR (Resilient Packet Ring). The RPR is now in the process of standardization in IEEE 802.17 as a L2 (layer-2) network protocol for ring-type IP packets.

A major feature of the RPR is that it allows free paths to be used for other communications to make effective use of the network bandwidth, i.e. it allows “spatial reuse”. Other features of the RPR include, for example, that using a bidirectional, counter-rotating dual-ring system provides ring networks with enhanced reliability and thus enables quick recovery from failures.

The spatial reuse, one feature of the RPR system, means that, in unicast communication between a single sender and a single recipient, the receiving node of the recipient captures a sent packet and then does not transfer the packet to forward nodes. The spatial reuse in the RPR thus keeps the network bandwidth available for nodes located forward of the receiving node (makes the bandwidth “space”). That is, a packet is not transferred to nodes located ahead of the receiving node in the direction in which information is transmitted on the ring network. This allows the nodes ahead of the receiving node to send/receive other packets. The ring network is thus capable of making effective use of the network bandwidth.

As a result, it is reported that the RPR can offer great utilization efficiency of ring networks, as high as 95%, in contrast with other ring networks which pass tokens in a circle, such as FDDIs and token rings.

However, multicast communication by the RPR, where multicast packets flow to all RPR nodes, prescribes rules against the spatial reuse. The same rules are defined also in systems original to leading vendors who laid the foundations of the RPR.

That is, since the RPR is a L2 network, broadcast frames, including multicast packets, flow to all RPR nodes in multicast communication using the RPR system. That is, it cannot be said that the spatial reuse of RPR is effectively utilized in multicast. Thus, while unicast communication generally achieves efficient utilization of bandwidth of ring networks, as high as 95%, it is difficult to attain the corresponding utilization efficiency in multicast communication.

The following technique that minimizes reduction of bandwidth utilization efficiency caused by broadcast frames is known. This technique uses a switching hub as an interface module. The switching hub includes an ARP server module that determines a relaying port on the basis of a filtering database. The switching hub provides the ARP server module with all broadcast frames received at the interface module and the ARP server module learns and registers source MAC addresses and source network addresses of the frames. The ARP server module assembles an ARP response frame when there is an entry that corresponds to the network address and responds from a receiving port (refer to Patent Document 1, for example).

Another technique about multicast on ATM networks is known which enables savings of sending/receiving bandwidth, savings of VC (Virtual Channel) management memory on machines and switches, and reduction of multicast connection time. In this technique, a cluster member and a multicast server perform conditional operations using a no-receive flag and a no-transmit flag to set only a required virtual channel (refer to Patent Document 2, for example).

However, the techniques disclosed in Patent Documents 1 and 2 do not consider IP multicast communication on ring networks.

[Patent Document 1]
JP 9-64900 A

[Patent Document 2]
JP 11-308234 A

### SUMMARY OF THE INVENTION

The present invention has been made in view of such problems of conventional techniques. That is, an object of the present invention is to achieve spatial reuse of bandwidth in multicast communication on a ring network.

The present invention adopts the means below in order to achieve the object.

That is, the present invention relates to a method for making effective use of a bandwidth in multicast communication on a ring network having information transmission directivity. In the ring network, a sending host and a receiving node which communicate by multicast on the ring network share entry information indicating nodes related to the multicast communication. Also, the sending node and the receiving node broadcast the entry information on the ring network, and share, among the nodes, topology information about a positional relation on the ring network. Also, the sending node determines a sending direction for sending multicast information by referring to the entry information and the topology information, and multicasts the information in the sending direction. Further, the receiving node discards the information when no other node in the sending direction receives the information.

In the multicast communication, a transmission of a packet involves one sending node and a plurality of receiving nodes. It is therefore necessary that the individual nodes hold the same information.

Accordingly, the present invention defines entry information and all nodes on the ring network hold the entry information. Also, the present invention provides topology information that stores information about positions of the nodes and combines the topology information and the entry information.

Thus, according to the present invention, it is possible, in the multicast communication, to allow the sending node to recognize receiving nodes, as in unicast communication.

The topology information stores a positional relation among nodes on the ring network, e.g. the order of arrangement of nodes. The positional relation is recognized using, e.g. MAC (Media Access Control) addresses of the nodes.

Also, according to the present invention, the entry information may include an address of the sending node and an address of the receiving node.

According to the present invention, the entry information includes the address of the sending node and the address of the receiving node, whereby each node can recognize other nodes as sending or receiving nodes by referring to the entry information.

Also, in the present invention, the topology information may include the sending direction and an address of the receiving node.

According to the present invention, the topology information includes the sending direction and the address of the receiving node, whereby each node can recognize relative positions of the nodes.

Also, in the present invention, the sending node receives the information from a sending host subordinate to the sending node. The sending node generates the entry information on the basis of the information.

According to the present invention, the sending node generates the entry information on the basis of information from the sending host and the entry information is transferred on the ring network, whereby the receiving node is capable of knowing the destination of the information (multicast packet).

Also, in the present invention, the receiving node receives reception request information which requests reception of the information, from a receiving host subordinate to the receiving node. The receiving node generates a reception request command in accordance with the reception request information, and sends the reception request command to the sending node.

According to the present invention, the receiving node receives reception request information from the receiving host and generates a reception request command on the basis of the reception request information, whereby each node is capable of recognizing whether other nodes receive the information or not, which enables effective use of the bandwidth in multicast communication on the ring network.

Also, in the present invention, the sending node updates the entry information in accordance with the reception request command. The sending node sends the updated entry information.

According to the present invention, the sending node updates the entry information on the basis of a reception request command and thus the sending node can easily deal with a variation in the number of nodes which receive the information, which enables efficient multicast to reception requesting nodes.

Also, in the present invention, the receiving node receives, from the receiving host, leaving request information which requests a halt of the reception of the information. The receiving node checks whether there is any other receiving host in accordance with the leaving request information and generates a deletion request command when there is no receiving host. Also, the receiving node sends the deletion request command to the sending node.

According to the present invention, the receiving node checks whether there is a receiving host on the basis of leaving request information, and when there is no receiving host, the receiving node generates a deletion request command. Thus, the receiving node is capable of grasping whether to receive multicast packets or not, which enables effective use of the bandwidth in multicast communication on the ring network.

Also, in the present invention, the sending node updates the entry information in accordance with the reception request command. The sending node sends the updated entry information.

According to the present invention, the sending node updates the entry information in accordance with a deletion request command so that each node can grasp the number of other receiving nodes, which enables effective use of the bandwidth in multicast communication on the ring network.

Also, in the present invention, the sending node detects from the sending host that transmission of the information is ended. The sending node generates a transmission end command for notifying the receiving node that the transmission of the information is ended. The sending node sends the transmission end command to the receiving node, and deletes the entry information in response to the end of the transmission.

According to the present invention, the sending node generates a transmission end command and deletes the entry information so that each node can grasp the states of other nodes, which enables effective use of the bandwidth in multicast communication on the ring network.

The present invention may be a program that realizes any of the functions above. The present invention may record such a program in a computer-readable storage medium.

Also, the present invention maybe a system in a ring network including a sending node and a receiving node which realizes any of the functions above.

### DESCRIPTION OF THE DRAWINGS

FIG. 1 shows an example of a ring network according to an embodiment of the present invention;

FIG. 2 is a flowchart of a main procedure for sending and receiving data according to the embodiment of the present invention;

FIG. 3 illustrates the format of an RPR data packet and the format of a multicast entry table according to the embodiment of the present invention;

FIG. 4 illustrates a topology table used to grasp relative positions of nodes in the embodiment of the present invention;

FIG. 5 illustrates the structure of a control command according to the embodiment of the present invention;

FIG. 6 illustrates the structure of a control response according to the embodiment of the present invention;

FIG. 7 is a process flow of transmission by an RPR node according to the embodiment of the present invention;

FIG. 8 is a diagram showing a process performed by a receiving node on the ring network according to the embodiment of the present invention;

FIG. 9 is a diagram showing a sending node N1 and a flow of the multicast entry table on the ring network realized by implementing the present invention;

FIG. 10 is a state transition diagram of a sending node of the embodiment of the present invention;

FIG. 11 is a state transition diagram of a receiving node of the embodiment of the present invention;

FIG. 12 is a flowchart of a process performed by a sending node of the embodiment of the present invention;

FIG. 13 is a flowchart of a process performed by a receiving node of the embodiment of the present invention;

FIG. 14 is a flowchart of a spatial reuse process of the embodiment of the present invention;

FIG. 15 is a diagram showing how the multicast packet flow according to the embodiment of the present invention differs from that of a conventional multicast packet sending system;

FIG. 16 shows an example of a multicast entry table according to the embodiment of the present invention;

FIG. 17 shows an example of a reception request command according to the embodiment of the present invention;

FIG. 18 shows an example of a reception response according to the embodiment of the present invention;

FIG. 19 shows an example of the multicast entry table according to the embodiment of the present invention, to which MAC addresses of receiving nodes, which are requesting reception, are added; and

FIG. 20 is a diagram showing processes performed by each node according to the embodiment of the present invention.

### DETAILED DESCRIPTION OF THE INVENTION

A preferred embodiment of the present invention is now described referring to the drawings.

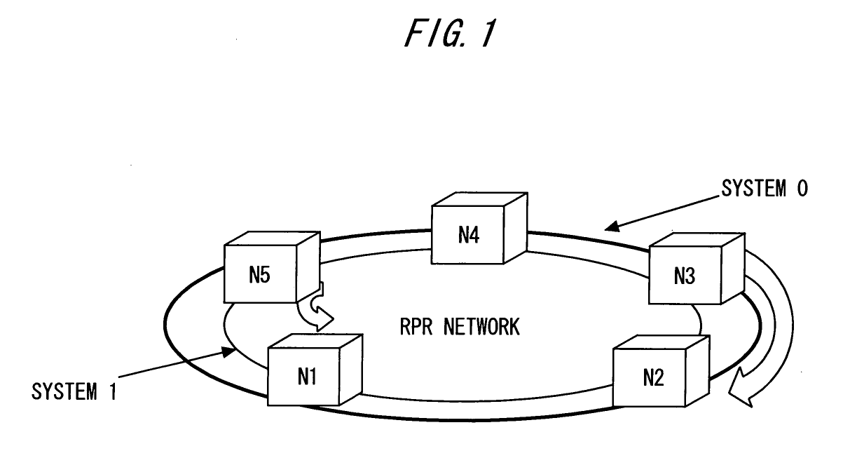

A method for effectively using bandwidth during multicast transmission on a ring network according to an embodiment of the present invention is now described referring to FIGS. 1 to 20.

### Principle of Operation

FIG. 1 shows the basic concept of the ring network of this embodiment. In this embodiment, description is given of an application of the present invention using the RPR as a ring network of the present invention.

The RPR network used in the present invention is an optical dual-ring network. Nodes are connected to the RPR network. The RPR network is formed of two rings including a system 0 and a system 1. The RPR is characterized in that data is transmitted on a ring of the shortest propagation distance (by the shortest route) according to the relative positions of a sending node and a receiving node on the ring network. The RPR is thus capable of selecting which of the system 0 and the system 1 data should be sent through. During this process, as will be described later, the sending node knows the position of the receiving node from a multicast entry table that contains entry information of the present invention and a topology table that contains topology information of the present invention. The ring network thus provides a network capable of making efficient use of the line.

A sending node of this embodiment has the following means according to the present invention. The sending node of this embodiment has entry information generating unit that generates entry information indicating nodes related to a multicast communication. The sending node according to this embodiment also has entry information sharing unit for sharing the entry information. Also, the sending node according to this embodiment has topology information sharing unit for sharing, among nodes, topology information about relative positions on the ring network. The sending node according to this embodiment also has entry information sending unit that broadcasts the entry information on the ring network. Also, the sending node according to this embodiment has sending direction determining unit that determines the sending direction in which information is multicast, by referring to the entry information and the topology information. The sending node according to this embodiment also has information sending unit that multicasts the information in that sending direction.

A receiving node according to this embodiment has the following unit according to the present invention. The receiving node of this embodiment has entry information receiving unit that receives the entry information indicating nodes related to the multicast communication. The receiving node according to this embodiment also has entry information sharing unit for sharing the entry information. Also, the receiving node according to this embodiment has topology information sharing unit for sharing, among nodes, the topology information about relative positions on the ring network. Also, the receiving node of this embodiment has sending direction reference unit that refers to the sending direction of multicast information. Also, the receiving node according to this embodiment has sending unit that sends the information in that sending direction. Also, the receiving node according to this embodiment has information discarding unit that discards the information when no receiving node for the information exists in the sending direction.

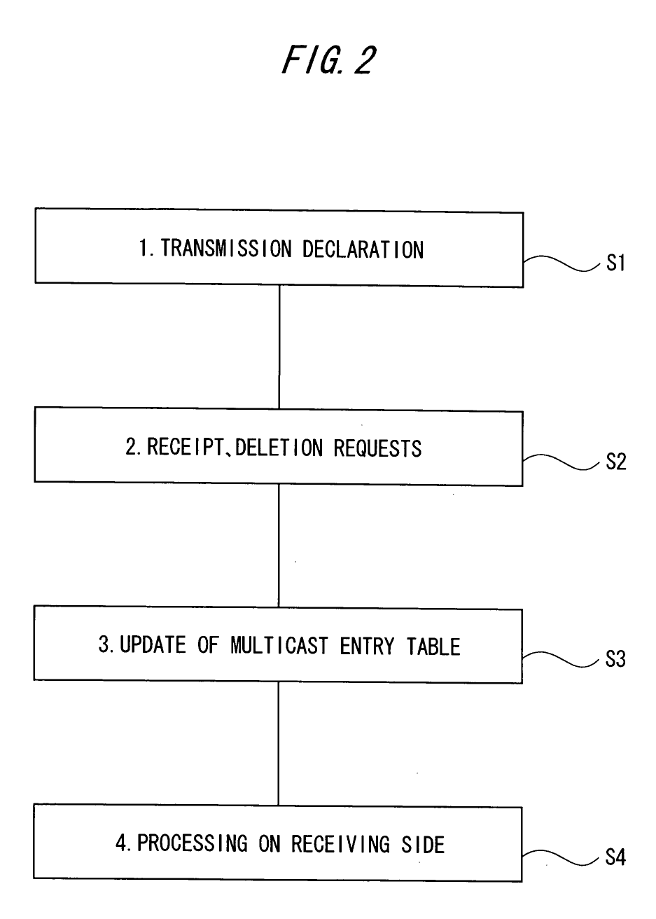

Next, FIG. 2 shows the main procedure for sending and receiving data according to this embodiment.

The data sending/receiving procedure of this embodiment includes transmission declaration which a sending node makes for transmission (step 1 in FIG. 2: the steps are hereinafter referred to simply as S1, S2, and so on), reception requesting and packet deletion requesting made by receiving nodes (S2), updating of a multicast entry table on the ring network (S3), and processing performed by the receiving nodes (S4).

Each step is now described. The transmission declaration is described first. First, a network that is subordinate to a node connected to the RPR includes a sending host that sends multicast packets (referred to as information in the present invention). This node, having the subordinate sending host, is regarded as a sending node. The transmission declaration is a process by which the sending node notifies other nodes that it is sending multicast packets. The reception requesting is a process by which a node (receiving node) having, on its subordinate network, a receiving host which receives the multicast packets makes a request to the sending node for the reception of packets. The packet deletion requesting is a process by which the network subordinate to the receiving node halts the reception of packets. The update of a multicast entry table is a process by which the sending node updates the multicast entry table in accordance with packet reception requests and deletion requests. The processing performed on the receiving side is a process by which receiving nodes process transmitted multicast packets.

### Multicast Entry Table Structure of Embodiment of the Present Invention

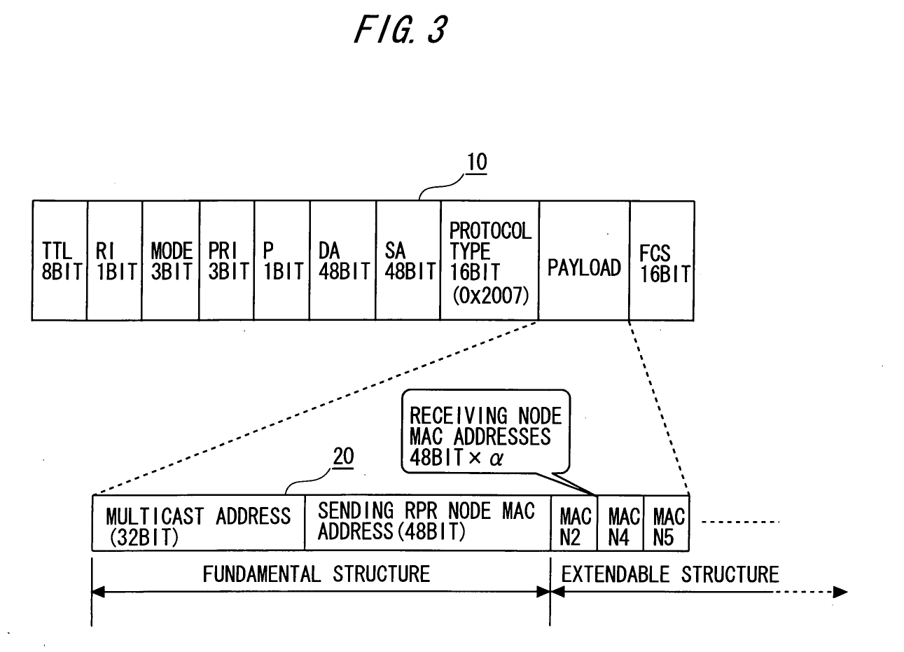

FIG. 3 illustrates the format of an RPR data packet and the format of the multicast entry table of this embodiment. Reference numeral 10 denotes the RPR data packet format and 20 denotes the multicast entry table format.

The RPR data packet 10 is formed of TTL (Time To Live) (8 bits) indicating a time for which the packet 10 lives on the network, RI (Ring Identifier) (1 bit), Mode (selection of packet type) (3 bits), Pri (Priority: priority of the packet) (3 bits), P (Parity bit: odd parity about 15 bits of the MAC header) (1 bit), DA (Destination MAC Address) (48 bits), SA (Source MAC Address) (48 bits), Protocol Type (type of the protocol used, where OX2007 indicates SRP (Special Reuse Protocol) control) (16 bits), Pay Load (an information field for transferring actual data), and FCS (Frame Check Sequence) (16 bits). The Payload accommodates the multicast entry table 20 of this embodiment.

The multicast entry table 20 is a table that contains information about a sending node and receiving nodes that join the multicast group which receives multicast packets (information) on the ring network. That is, the multicast entry table 20 is a table showing nodes related to the multicast communication.

The multicast entry table 20 includes Multicast address (an address specified for multicast communication) (32 bits), Sending node MAC address (an address for identifying an individual node) (48 bits), and Receiving node MAC address field. Note that the Receiving node MAC address field can be added in correspondence with the number of receiving nodes. The receiving node MAC address length is variable because the number of bits (the number of storable MAC addresses) increases as the number of receiving nodes increases.

In the multicast entry table 20, the multicast address and the Sending node MAC address form the fundamental structure and the Receiving node MAC addresses form an extendable structure. The receiving node MAC address field is referred to as an extendable structure because the number of MAC addresses varies in correspondence with the number of receiving nodes. The first 4 bits of the multicast address are (1110).

Thus, the multicast entry table 20 of this embodiment enables the individual nodes to hold and share information as to whether other nodes are the sending host or receiving nodes. Therefore, this embodiment enables effective use of a bandwidth in multicast communication on the ring network.

### Topology Table of Embodiment of the Present Invention

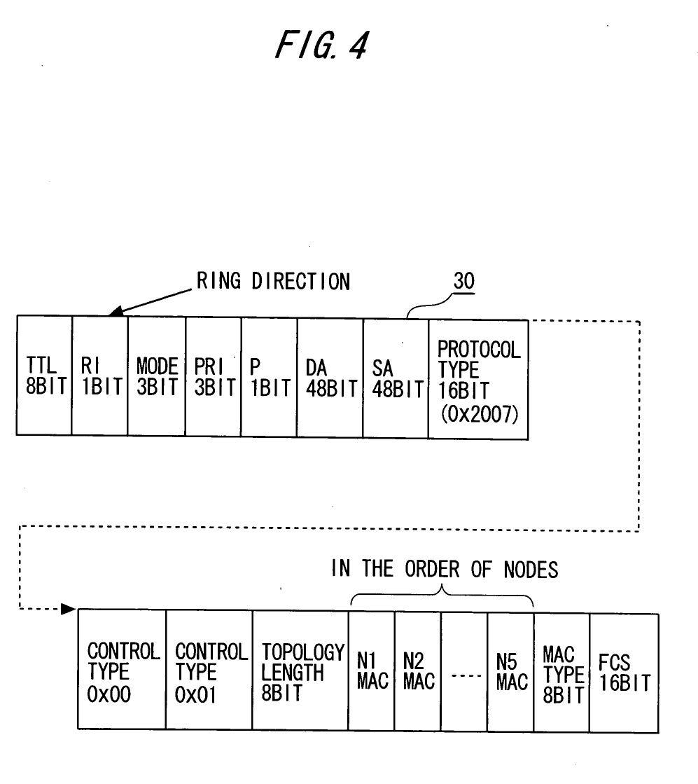

Next, a topology table of this embodiment, which is used to grasp relative positions of individual nodes, is described. Each node has a topology table. This topology table stores results of RPR topology detection. The RPR topology is information about the positions of individual nodes on the RPR. The topology table is created with MAC addresses of the nodes on the link and ring status information, as the nodes on the ring regularly send topology detection packets on the RPR network. In this embodiment, the topology table allows individual nodes to grasp relative positions of the nodes on the ring system 0 and system 1. The topology table is as shown in FIG. 4. FIG. 4 shows an example of the topology table of the present invention at the reference numeral 30.

The topology table 30 includes TTL (Time To Live) (8 bits) indicating a time for which the packet 10 lives on the network of the table 30, RI (Ring Identifier) (1 bit), Mode (selection of packet type) (3 bits), Pri (Priority: priority of the packet) (3 bits), P (Parity bit: odd parity about 15 bits of the MAC header) (1 bit), DA (Destination MAC Address) (48 bits), SA (Source MAC Address) (48 bits), Protocol Type (type of the protocol used, where OX2007 indicates SRP control) (16 bits), Control type (indicating a control command type, where 0X00 indicates a transmission end command, and 0X01 indicates a request reception command) (8 bits), a MAC address of the receiving node, the type of the MAC address, and FCS (Frame Check Sequence) (16 bits).

In this embodiment, the topology table 30 is generated so that nodes can hold common positional information about individual nodes. Therefore, in this embodiment, a sending node is capable of grasping positional relation about all nodes. Note that, while FIG. 4 shows an example in which the arrangement of receiving node MAC addresses coincides with the arrangement on the network, the two arrangements do not necessarily have to coincide with each other in the present invention.

### Control Command Structure

Next, the structure of control commands of this embodiment is described.

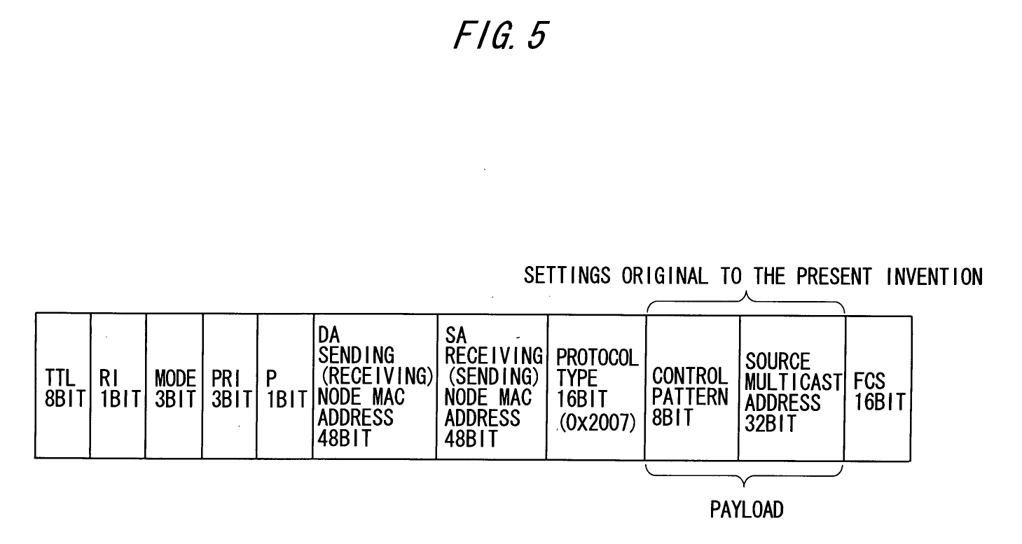

Different control commands are used when a sending node ends transmission, when a receiving node makes a reception request to a sending node, and when a receiving node makes a deletion request to a sending node. The structure of control commands is described referring to a transmission end command by way of example. FIG. 5 shows an example of the transmission end command denoted by 40.

The control command 40 includes TTL (Time To Live) (8 bits) indicating a time for which the packet 10 lives on the network, RI (Ring Identifier) (1 bit), Mode (selection of packet type) (3 bits), Pri (Priority: priority of the packet) (3 bits), P (Parity bit: odd parity about 15 bits of the MAC header) (1 bit), DA (Destination MAC Address of the sending and receiving nodes) (48 bits), SA (MAC Address of the sending and receiving nodes corresponding to DA) (48 bits), Protocol Type (type of the protocol used, where 0X2007 indicates SRP control (16 bits), Pay Load (an information field for transferring actual data), and FCS (Frame Check Sequence) (16 bits). The Payload accommodates the control pattern information of this ring network (8 bits), and the source multicast address.

In this embodiment, the control pattern is defined as follows:

(1) 0X00: a transmission end command (a command sent to receiving nodes when a sending node ends multicast packet transmission).

(2) 0X01: a reception request command (a command sent by unicast to a sending node from a receiving node making a request for the reception of multicast packets).

(3) 0X02: a deletion request command (a command sent to a sending node when a receiving node makes a deletion request to leave the multicast group).

The packet of the control command 40 is broadcast to other nodes when the node requests other nodes to perform a process in accordance with the control command.

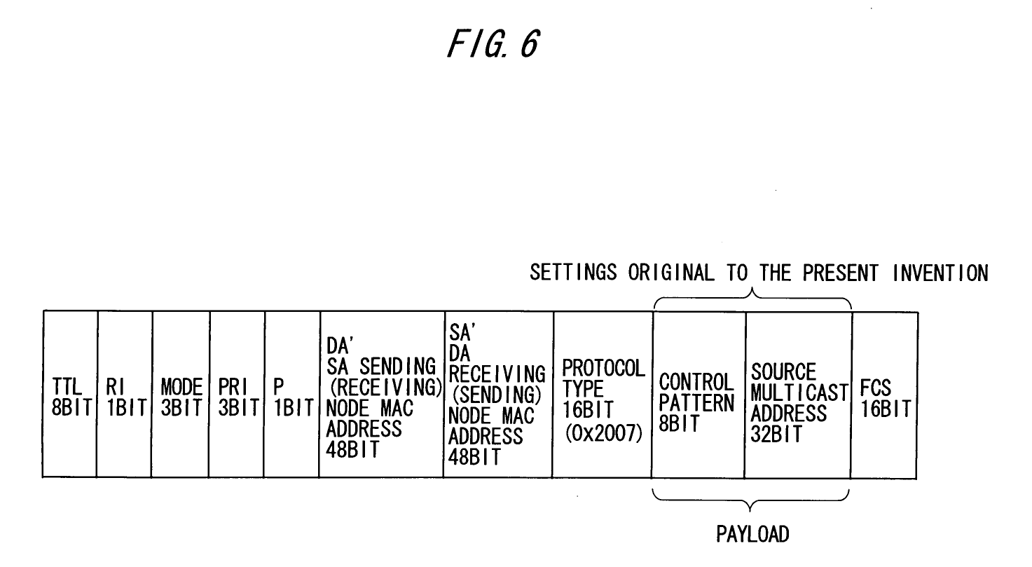

Anode receiving the control command sends a control response back to the sending node, so as to report the arrival of the control command. Reference numeral 50 of FIG. 6 indicates the structure of a control response.

The control response 50 includes TTL (Time To Live) (8 bits) indicating a time for which the packet 10 lives on the network, RI (Ring Identifier) (1 bit), Mode (selection of packet type) (3 bits), Pri (Priority: priority of the packet) (3 bits), P (Parity bit: odd parity about 15 bits of the MAC header) (1 bit), D′A (SAMACAddress) (48 bits), S′A (DAMACAddress) (48 bits), Protocol Type (type of the protocol used, where 0X2007 indicates SRP control (16 bits), Pay Load (an information field for transferring actual data), and FCS (Frame Check Sequence) (16 bits). The Payload accommodates the control pattern information which is originally set in this embodiment (8 bits) and source multicast address (32 bits).

In this embodiment, the control pattern of the control response 50 is defined as follows:

(4) 0X10: a transmission end response (a response by which a receiving node notifies the sending node of the arrival of a transmission end command).

(5) 0X11: a reception request response (a response by which a sending node notifies the receiving node of the arrival of a reception request command).

(6) 0X12: a deletion request response (a response by which the sending node notifies a receiving node of the arrival of a deletion request command).

### Transmission Declaration

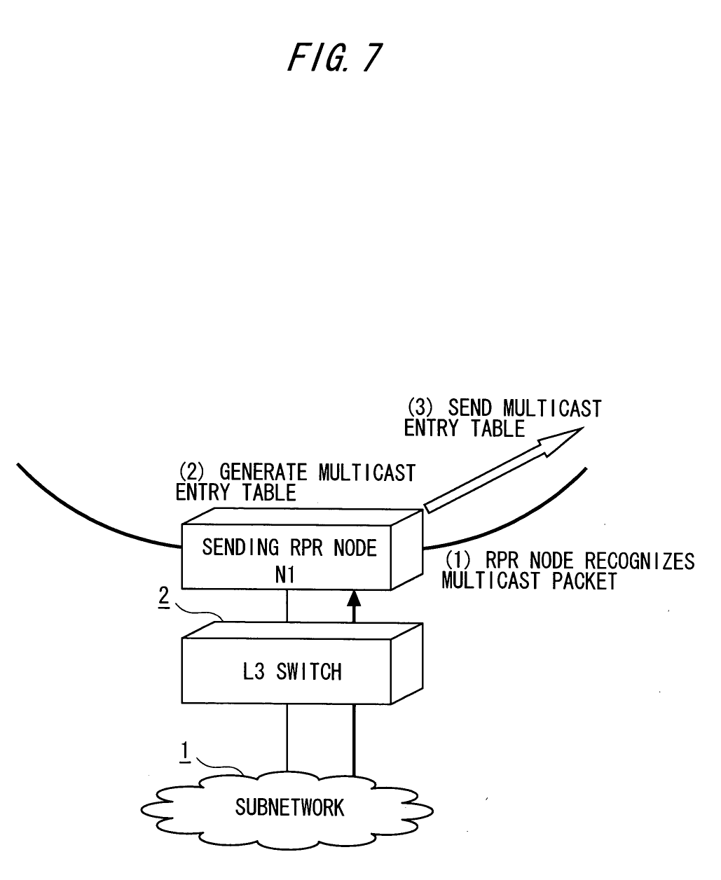

FIG. 7 is a process flow of transmission from an RPR node. While this embodiment uses the PIM-SM (Protocol Independent Multicast Sparse Mode) as the routing protocol, this embodiment is not limited to the PIM-SM and the present invention is also applicable to other typical protocols.

In FIG. 7, a sending host of the present invention (not shown) is present in the L3 (layer-3) subnetwork 1 that is subordinate to the sending node N1, and the sending host sends a multicast packet to the sending node N1.

The multicast packet thus sent is received at the L2 (layer-2) sending node N1 via an L3 switch 2.

The sending node N1 uses snooping to recognize the multicast address from the subordinate L3 network. ((1) in FIG. 7). The snooping is a technique for snooping into information from a higher layer to make it recognizable in the L2 network, and this embodiment performs snooping on multicast packets, PIM-Join (Join request) packets, and Prune (Leave request information) packets.

The sending node N1 then creates a multicast entry table as will be described later, using the multicast address, RPR node MAC address, and ring direction information (2).

The sending node N1 broadcasts the created multicast entry table to all nodes connected to the network (3). This is called “transmission of a multicast entry table”. Nodes receiving the multicast entry table hold the multicast entry table.

According to the process steps (1) to (3), this embodiment allows all nodes connected to the network to recognize the MAC address of the sending node N1. Thus, in this embodiment, the multicast entry table sent to a receiving node first informs the receiving node of the destination of a reception request command and a deletion request command (the destination is the node which sent the multicast packet).

### Reception Request

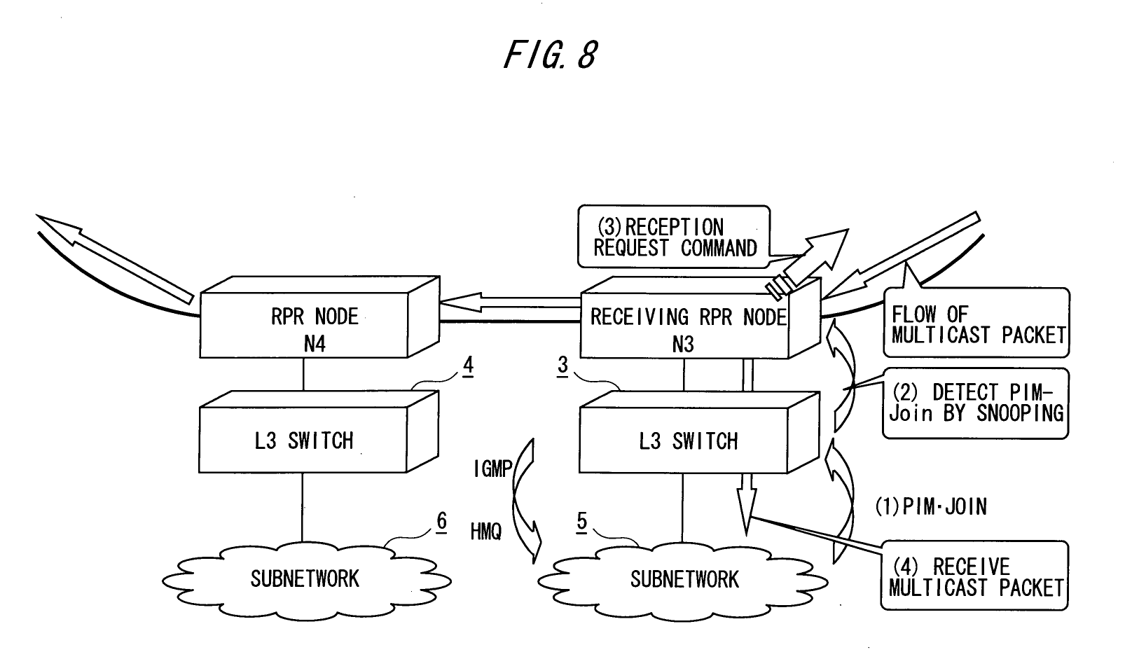

FIG. 8 shows a process at a receiving node on the ring network of this embodiment. In this embodiment, it is assumed that a L3 subnetwork under the receiving node N3 sends a reception request.

First, in order that a receiving host of this embodiment (not shown) on the subnetwork 5 under the receiving node N3 may receive a multicast packet, an IGMP HMQ (Internet Group Management Protocol Host Membership Query) is sent on the network and then the L3 switch 3 sends a PIM-Join to an adjacent L3 switch 4 ((1) in FIG. 8). The PIN-Join is information for requesting reception which is sent when a sending host declares to the sending node that it joins the multicast group.

Next, the receiving node N3 recognizes the PIN-Join from the L3 switch 3 by snooping (2). The receiving node N3 generates a reception request command on the basis of the multicast entry table generated at the sending node (not shown) (3). The receiving node N3 then sends to the sending node N1, by unicast, the reception request command that contains the MAC address of the receiving node N3. Then the sending node receives the reception request command and updates the multicast entry table.

At the receiving node N3, the subnetwork 5 receives the multicast packet from the sending node N1 via the L3 switch 3 (4).

The RPR node N4 receives no request for the reception of the multicast packet from the subnetwork 6 under the L3. That is, the RPR node N4 has no subordinate receiving host. Therefore the RPR node N4 does not send a reception request command to the sending node N1. The RPR node N4 receives the multicast entry table update packet. The RPR node N4 transfers the multicast packet to the next node without receiving it (lets the multicast packet pass through).

Thus, according to the procedure of this embodiment, a node that does not receive information lets the multicast packet pass through so as to prevent flow of undesired packets on the network, thereby enabling effective use of the bandwidth.

### Deletion Request

At reception of a multicast packet, the IGMP HMQ from the receiving node N3 to the subordinate subnetwork may receive no response from the subnetwork. That is, the receiving host has disappeared. Then, the L3 switch 3 sends a Prune (leaving request information) to the receiving node. The receiving node N3 detects the Prune signal by snooping. Then the receiving node N3 generates a deletion request command to the sending node (not shown). The receiving node N3 notifies the sending node of its own MAC address by unicast. Receiving the deletion request command, the sending node prunes the multicast entry table. The sending node broadcasts to the receiving node N3 the information of the updated multicast entry table. Receiving the updated multicast entry table, the receiving node leaves the multicast group.

### Update of Multicast Entry Table

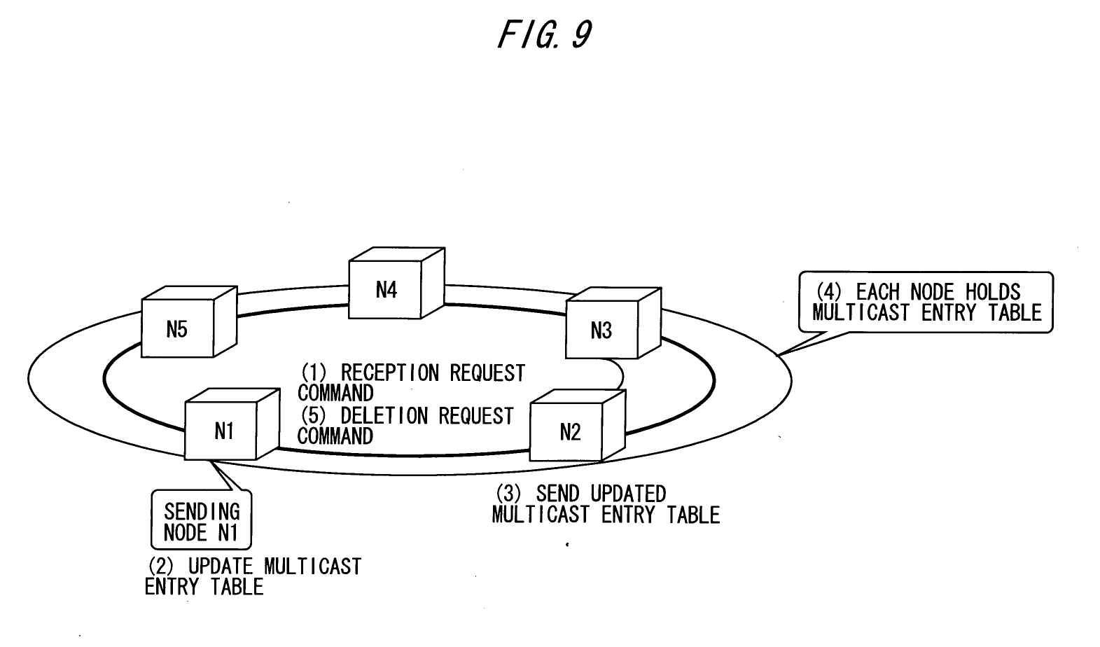

Next, the update of the multicast entry table of this embodiment is described referring to FIG. 9. FIG. 9 shows the sending node N1 and a flow of the multicast entry table on the ring network of this embodiment.

In this embodiment, a receiving node receives data through a procedure as shown below.

First, the receiving node sends a reception request command to the sending node N1 ((1) in FIG. 9). The sending node N1 receives the reception request command and then updates the multicast entry table (2). Then the sending node N1 broadcasts the updated multicast entry table to each node (3).

In this invention, a receiving node halts reception of data through a procedure as shown below.

First, the receiving node sends a deletion request command to the sending node N1 ((5) in FIG. 9). Receiving the deletion request command, the sending node N1 updates the multicast entry table (2). The sending node N1 then broadcasts the updated multicast entry table to each node (3). Each node holds the received multicast entry table (4).

### Data Transmission

With the sending node N1 having updated the multicast entry table, and with the multicast entry table having been broadcast to each node on the ring network, the sending node N1 then multicasts packet information, e.g. image.

A receiving node determines whether to transfer the received multicast packet information to the next node or to discard the information, on the basis of the multicast entry table held in (4) of FIG. 9.

### Processing by Receiving Node

This embodiment combines the multicast entry table and the topology detection so that information can be multicast only to requesting nodes.

For this purpose, each node holds a topology map created by the topology detection and the multicast entry table, and when no node located ahead of it is making a request for reception of data, then the node captures the data and discards it. Also on the basis of the topology map and the multicast entry table, when there is a data reception requesting node ahead of it, the node captures data and forwards the data to the next node.

Specifically, a receiving node performs the process steps below.

First, the receiving node identifies the ring on which the incoming multicast entry table flows. That is, the receiving node detects whether the ring is the system 0 or the system 1.

Next, on the basis of the detected multicast entry table and topology, the receiving node checks whether any of the next and subsequent nodes is requesting information.

The receiving node captures information and, when the next or subsequent node is requesting the information, the receiving node transfers the information to the next node on the network. When there is no other node requesting the information, then this piece of information is undesired traffic data, and so the receiving node discards the information.

### Transitions of States of Sending and Receiving Nodes

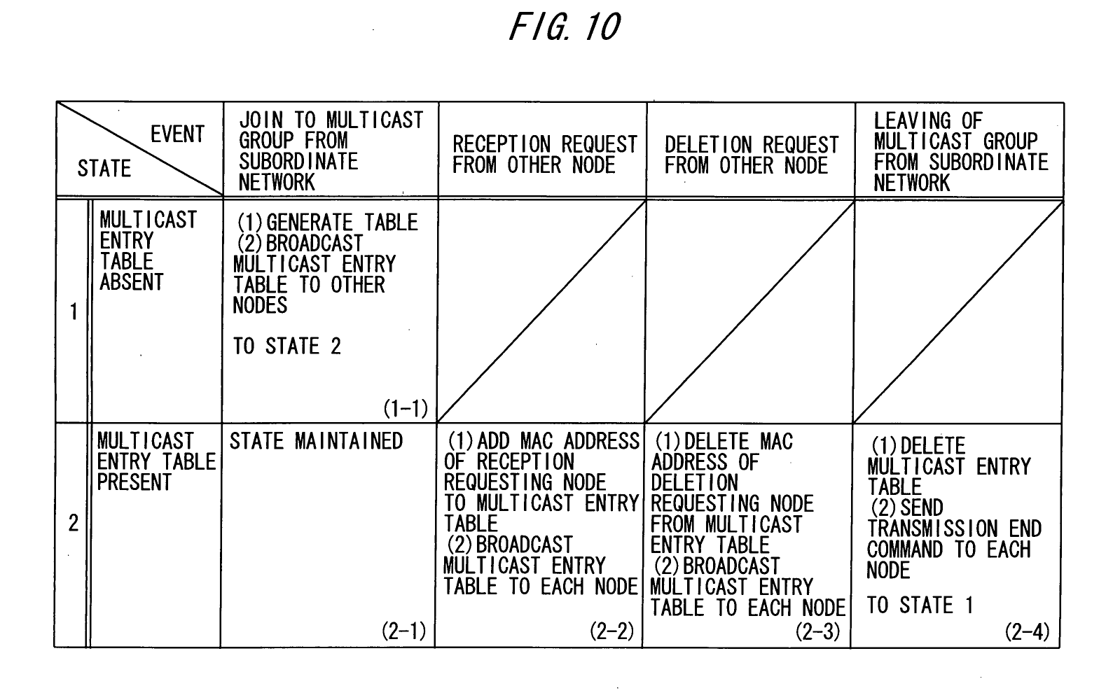

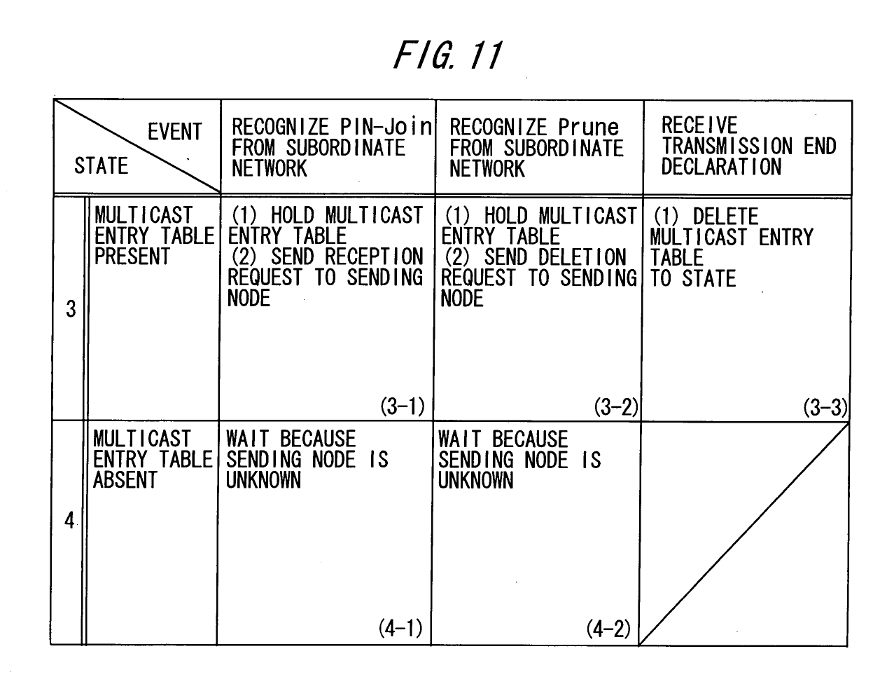

Next, FIG. 10 shows a state transition of a sending node of this embodiment. FIG. 11 shows a state transition of a receiving node of this embodiment.

(1) State Transition of Sending Node

A state transition of a sending node is described referring to the state transition table of FIG. 10.

In FIG. 10, a state in which the receiving node has no multicast entry table is referred to as a state 1 and a state in which the receiving node has a multicast entry table is referred to as a state 2.

In the state 1, with a multicast group join request from the subordinate network, the sending node creates a multicast entry table and distributes the multicast entry table to other nodes. At this time, the sending nodes transit the state 1 to the state 2 (1-1 in FIG. 10).

In the state 2, with a multicast group join request from the subordinate network, the sending node keeps the state (1-1) (2-1).

When the sending node receives an information reception request from some other node, it adds the MAC address of the reception requesting node to the multicast entry table and broadcasts the multicast entry table to each node (2-2).

With an information deletion request from some other node, the sending node deletes the MAC address of the deletion requesting node from the multicast entry table and broadcasts the multicast entry table to each node (2-3).

When the subordinate network makes a request for leaving the multicast group, the sending node deletes the multicast entry table it holds and sends a transmission end command to each node (2-4).

(2) State Transition of Receiving Node

A state transition of a receiving node is described referring to the state transition table of FIG. 11.

In FIG. 11, a state in which the receiving node has a multicast entry table is referred to as a state 3 and a state in which the receiving node has no multicast entry table is referred to as a state 4.

In the state 3, with a PIM-Join indicating a multicast group join request from the subordinate network, the receiving node sends a reception request command to the sending node (3-1 in FIG. 11). Then the MAC address of this receiving node is added to the multicast entry table and it is broadcast.

When the receiving node recognizes a Prune signal from the subordinate network, the receiving node sends, to the sending node, a request for deletion of the MAC address of the receiving node (3-2).

When receiving a transmission end command from the sending node, the receiving node deletes the multicast entry table being held and changes from the state 3 to the state 4 (3-3).

In the state 4, with a PIM-Join indicating a multicast group join request from the subordinate network, the receiving node waits because no multicast entry table is present and the sending node is unknown (4-1).

When recognizing a Prune signal from the subordinate network, the receiving node waits because there is no multicast entry table and the sending node is unknown (4-2).

### Process Flowchart Next, processes performed by a sending node and a receiving node of this embodiment and a process for the spatial reuse are described referring to the flowcharts.

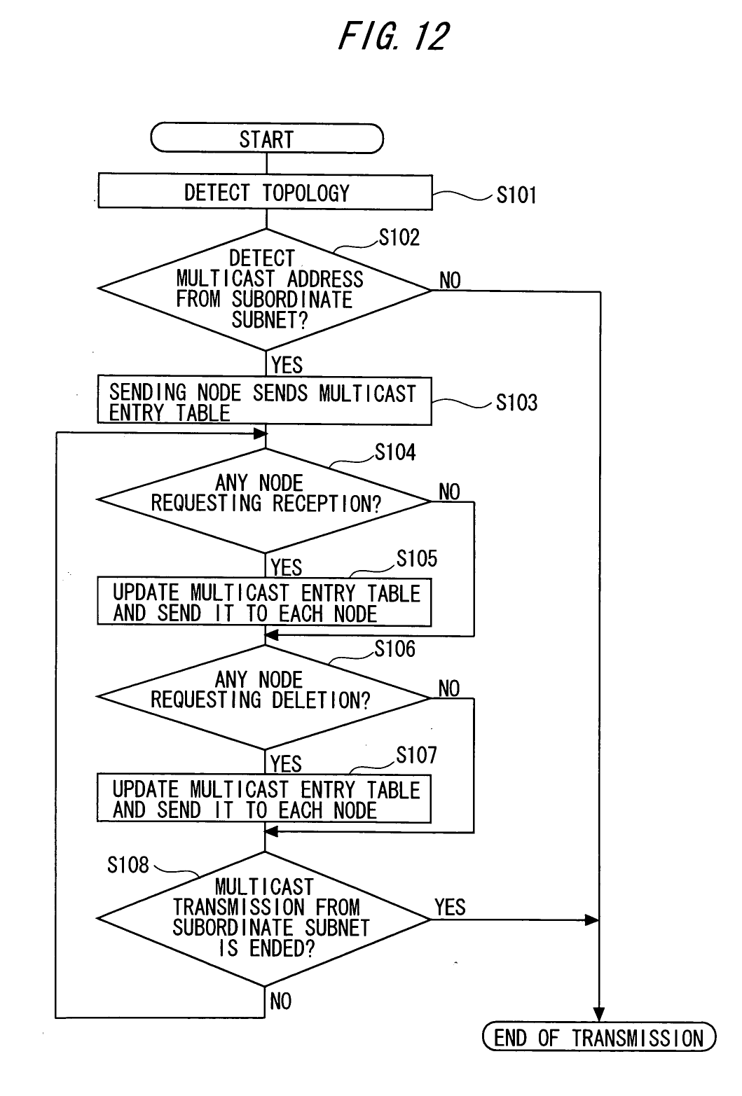

First, a process performed by a sending node of this embodiment is described referring to the flowchart of FIG. 12.

The sending node detects a topology table to grasp relative positions of individual nodes (step 101 in FIG. 12: steps are hereinafter referred to simply as S101 and so on).

The sending node then checks whether a multicast address is detectable from the subordinate network (S102). When the sending node detects a multicast address in this step, the sending node takes over the processes in step 103 and its subsequent steps. On the other hand, when the sending node does not detect a multicast address, it ends the process. Then the ring network performs normal transmission processing other than multicasting.

When detecting a multicast address, the sending node sends a multicast entry table onto the ring network (S103).

The sending node then checks whether any node is requesting reception (S104). When there is a receiving node in this step, the sending node conducts the process in step 105, and when there is no receiving node, it conducts the process in step 106.

When there is a receiving node, the sending node updates the multicast entry table by adding the MAC address of the receiving node and sends the multicast entry table to each node (S105). In this case, the sending node broadcasts the multicast entry table.

Next, the sending node checks whether a request for deletion of a reception request is present (S106). When there is a deletion request, the sending node updates the multicast entry table reflecting the deletion request command and sends the multicast entry table to each node (S107). In this case, too, the sending node broadcasts the multicast entry table. When there is no deletion request, the process advances to step 108.

The sending node then checks whether the subordinate network has finished the transmission of information with multicast packets (S108). When the multicast packet transmission is finished, the sending node broadcasts a transmission end command to the receiving nodes (S109). After sending the transmission end command, the sending node updates the multicast entry table and sends it to each node (S110) and ends the process. When the multicast packet transmission is not ended yet, the process returns back to step 104.

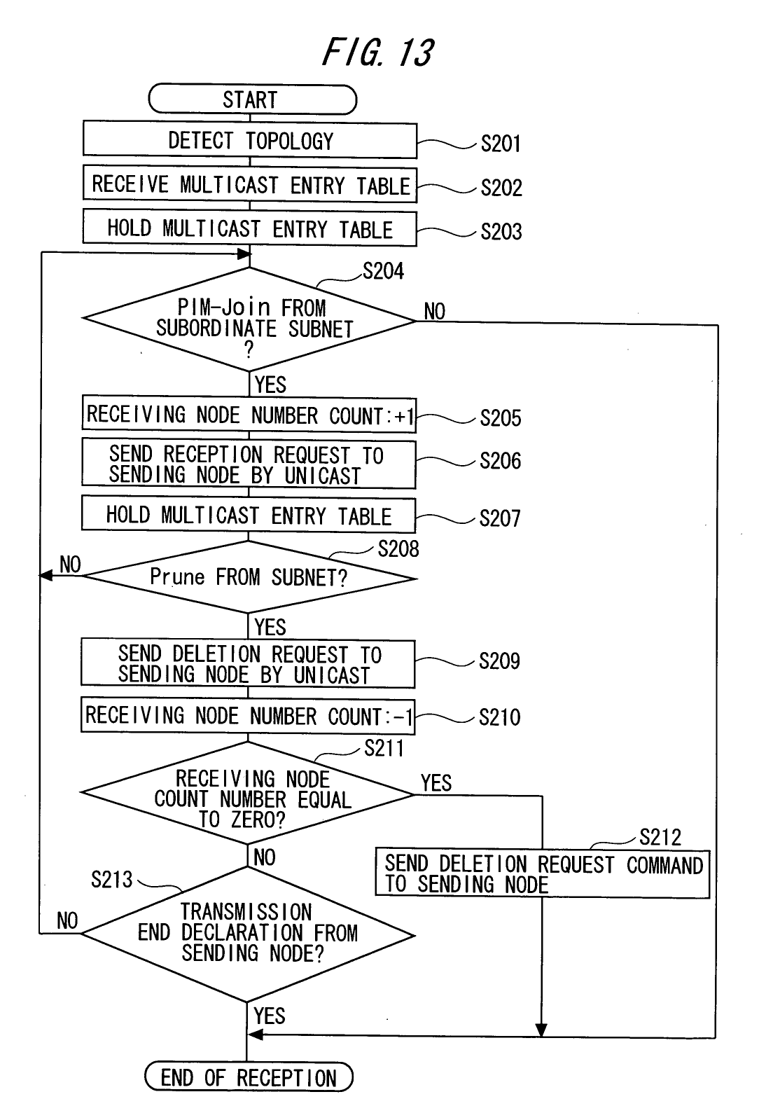

Next, a process performed by a receiving node of this embodiment is described referring to the flowchart of FIG. 13.

First, the receiving node detects a topology table to grasp relative positions of individual nodes (step 201 in FIG. 13: steps are hereinafter referred to simply as S201 and so on).

The receiving node receives a multicast entry table from a sending node (S202) and holds the multicast entry table (S203).

Next, the receiving node detects whether a PIM-Join is provided from the subordinate network (S204). When there is a PIM-Join, the receiving node conducts the process in step 205. When there is no PIM-Join, the receiving node ends the process. Then the ring network performs normal transmission processing other than multicasting.

When a receiving host on the network subordinate to the receiving node provides a PIM-Join, the receiving node increases by one the number of receiving hosts in the multicast entry table it holds (S205).

Then the receiving node sends a reception request command to the sending node by unicast (S206). After sending, the receiving node holds the multicast entry table (S207).

After sending the reception request command, the receiving node detects whether there is a Prune signal from a receiving host on the subordinate network (S208). When it receives no Prune signal, the process returns to step 204, and when it receives a Prune signal, it conducts the process in step 209.

The receiving node decreases by one the number of receiving hosts in the multicast entry table (S209).

The receiving node then checks whether the number of receiving hosts is zero, i.e. whether there is any node receiving the information (S210). When the number of receiving hosts is zero, the receiving node sends a deletion request command to the sending node (S211). When the number of receiving hosts is not zero, the receiving node checks whether a transmission end command (declaration) has been provided from the sending node (S212).

When finishing steps 211 and 212, the receiving node ends the process.

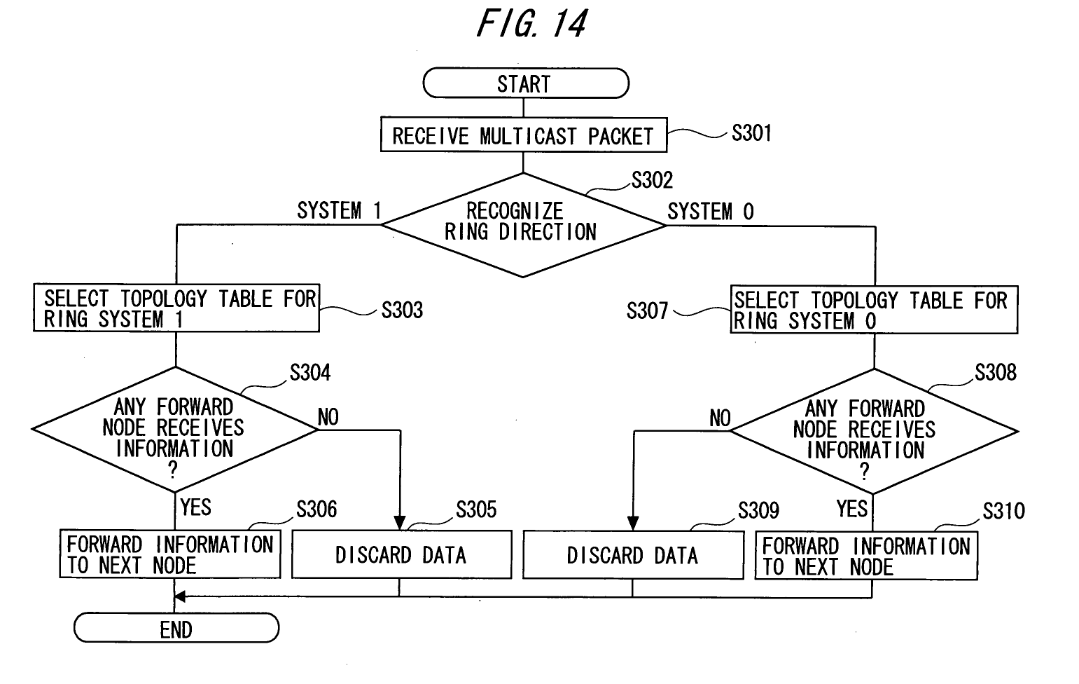

Next, a process for the spatial reuse of this embodiment is described referring to the flowchart of FIG. 14.

First, the receiving node receives a multicast packet that contains information therein (step 301 in FIG. 14; each step is hereinafter referred to simply as S301 or the like). Then, the receiving node checks whether the ring direction of the received multicast packet is the system 0 or the system 1 (S302). When the ring direction is the system 1, the receiving node conducts the process in step 303, and when the ring direction is the system 0, it conducts the process in step 307.

When the ring direction corresponds to the system 1, the receiving node selects a topology table for the ring direction system 1 (S303). The ring direction is selected by referring to “R1” in the topology table 30 of FIG. 4 which indicates the ring direction. However, the ring network may use a single topology table. In this case the ring direction can be set on the basis of R1.

After selecting the ring direction, the receiving node judges whether a node located forward of it will receive the information (S304). Then, when no forward node receives the information, the receiving node discards the information (S305) When a forward node receives the information, the receiving node forwards the information to the next node (S306). When finishing steps 305 and 306, the receiving node ends the process.

When the ring direction corresponds to the system 0, the receiving node selects a topology table for the ring direction system 0 (S307). The ring direction is selected by referring to “R1” in the topology table 30 of FIG. 4 which indicates the ring direction.

After selecting the ring direction, the receiving node judges whether a node located forward of it will receive the information (S308). Then, when no forward node receives the information, the receiving node discards the information (S309). When a forward node receives the information, the receiving node forwards the information to the next node (S310). When finishing steps 305 and 306, the receiving node ends the process.

### Embodiment

Next, a specific embodiment of the present invention is described.

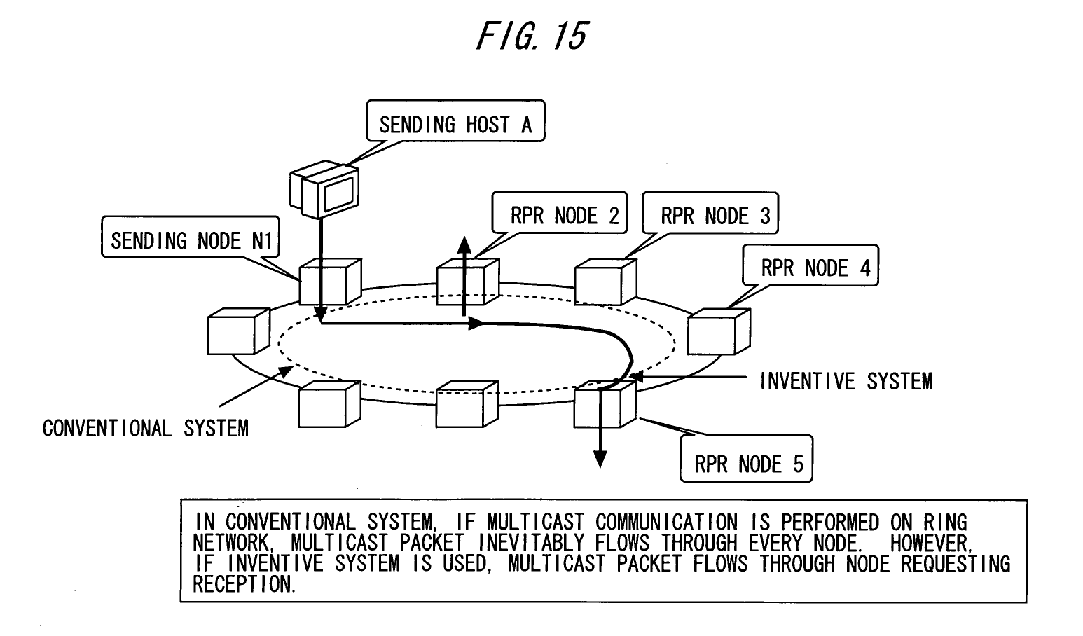

FIG. 15 shows how the flow of multicast packets of the present invention differs from that of a conventional multicast packet transmission system. This embodiment assumes that the node N1 is the sending node and the nodes N2 and N5 are receiving nodes. A multicast packet (information) sent from the sending host A is received at the receiving nodes N2 and N5 via the sending node N1.

In the conventional system, the multicast packet passing on the RPR ring network is always provided to all nodes. However, according to the present invention, the multicast packet is provided only to nodes which request reception.

In this embodiment, the sending node and receiving nodes grasp the positional relation of the nodes on the basis of the topology table 30 shown in FIG. 4.

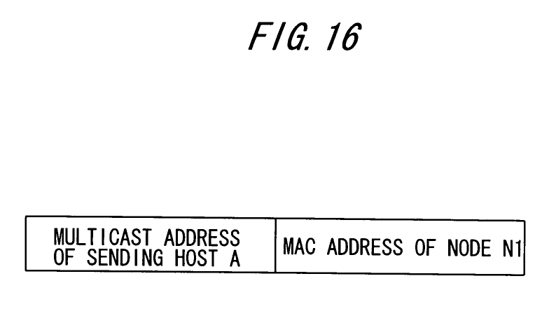

The sending node N1 recognizes a multicast address from the subordinate network by snooping and then the sending node N1 generates a multicast entry table as shown in FIG. 16.

The multicast entry table of FIG. 16 contains the multicast address of the sending host under the sending node and the MAC address of the sending node N1.

The sending node N1 broadcasts the multicast entry table to all nodes.

Each receiving node receives the multicast entry table and holds the multicast entry table.

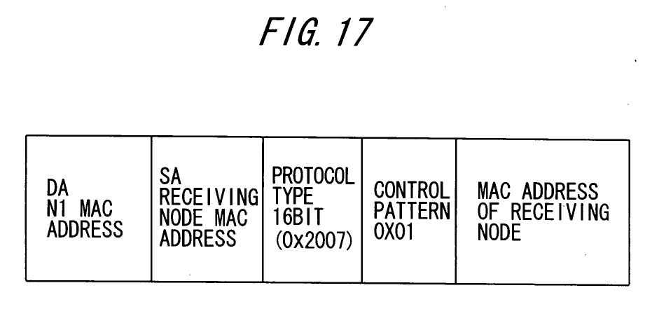

Also, each receiving node checks by snooping to see whether a PIM-Join from the subordinate network is present or not. When there is a PIM-Join, the receiving node generates a reception request command as shown in FIG. 17 for the sending node N1 described in the multicast entry table.

The reception request command of FIG. 17 contains the DA of the command in the network (the MAC address of the sending node N1), SA (the MAC address of the receiving node), Protocol Type (the type of the protocol used, where 0X2007 indicates SRP control) (16 bits), and Payload (an information field for transferring actual data), where the Payload contains the reception request command of the control pattern 0X01 (a command sent by unicast to a sending node from a receiving node to request reception of a multicast packet). The Payload also contains the MAC address of the receiving node.

The receiving node sends the reception request command by unicast to the sending node N1.

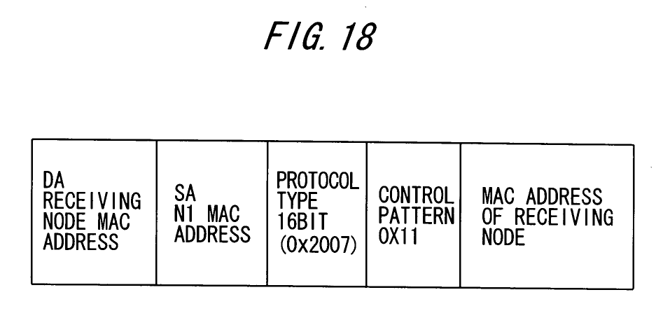

Receiving the reception request command, the sending node N1 sends by unicast a reception response to the reception request command, to the receiving node which is requesting reception. FIG. 18 shows an example of the reception response.

The reception response of FIG. 18 contains the DA of the response in the network (the MAC address of the receiving node), SA (the MAC address of the sending node), Protocol Type (the type of the protocol used, where 0X2007 indicates SRP control) (16 bits), and Payload (an information field for transferring actual data), where the Payload contains the reception request response of the control pattern 0X11 (a response sent to a receiving node from a sending node to report the reception of the reception request command). The Payload also contains the MAC address of the receiving node.

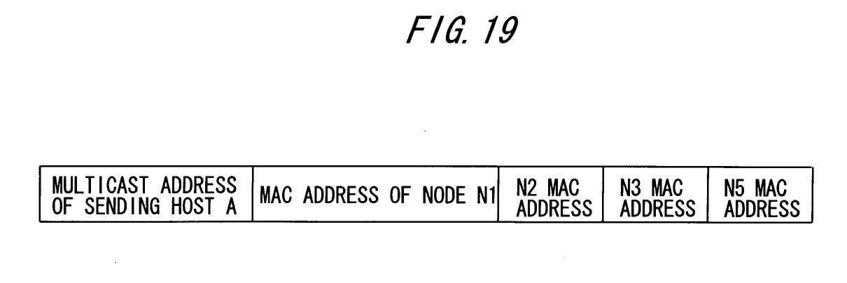

Also, the receiving node adds, to the multicast entry table of FIG. 16, the MAC address of the receiving node which is requesting reception and the multicast entry table is sent by multicast to all nodes. Other nodes hold the multicast entry table. FIG. 19 shows an example of the multicast entry table to which receiving node MAC addresses have been added.

As compared with the multicast entry table of FIG. 16, the multicast entry table of FIG. 19 additionally contains the MAC addresses of the receiving nodes which receive the multicast packet.

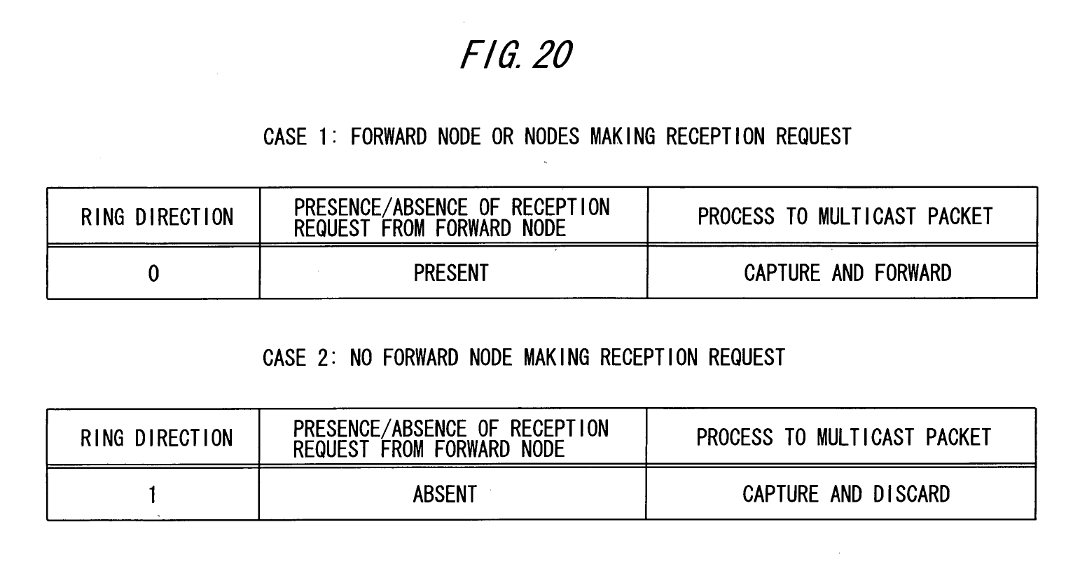

After detecting the topology and receiving the multicast entry table, each node provides control as shown in the process table of FIG. 20.

In FIG. 20, in this embodiment, the receiving node N2 and the RPR nodes N3 and N4 not receiving information (which ignore the information) correspond to the case 1 (a case in which a node or nodes forward of the own node are requesting reception). Also, in this embodiment, the receiving node N5 corresponds to the case 2 (a case in which no node forward of the next node is requesting reception). According to FIG. 20, each node is capable of grasping the positional relation of the nodes from the ring direction in the topology table and grasping the receiving nodes from the multicast entry table, and so each node decides whether to discard or forward the information according to the tables.

According to the present invention, the receiving node N5 performs the process of the case 2 and therefore the multicast packet is not forwarded to nodes located ahead of the receiving node N5, which allows effective use of the bandwidth of the ring network, i.e. allows the spatial reuse.

### Other embodiments

The method, program, and device for making effective use of a bandwidth on an RPR multicast network of the present invention are not limited to the embodiment above, and it is understood that numerous other modifications and variations can be devised without departing from the scope of the present invention.

For example, a sending host under a sending node may end transmission through the following procedures:

In a first procedure, the sending RPR node constantly monitors the sending host (sends Query to the sending host at predetermined time intervals) and judges that the sending node has ended the transmission when the response from the sending host disappears.

A second procedure below is also possible. A time-limit header is added (e.g. 8 bits) to the multicast entry table and held in the sending node. In the entry table thus held, the value in the time-limit header is decreased as a predetermined time passes. When a new multicast packet arrives before the time-limit header value becomes zero, then the time-limit header value recovers the initial value. When the time-limit header value attains zero, it is determined that there is no sending host any longer.

Also, while this embodiment uses the PIM-SM (Protocol Independent Multicast Sparse Mode) as the routing protocol, this embodiment is not limited to the PIM-SM but other typical protocols, too, are applicable to the present invention.

This embodiment may be a program that realizes any of the functions described above. This embodiment may record such a program in a computer-readable storage medium.

This embodiment may be a system for a ring network including a sending node and receiving nodes that realizes any of the functions above.

In multicast communication on a ring network, the present invention allows a sending node to recognize receiving nodes so that the sending node can send data only to the receiving nodes which request information, and thus multicast packets do not flow to other nodes and effective use of a bandwidth, i.e. spatial reuse, is achieved in multicast communication.

1. A method for making effective use of a bandwidth in multicast communication on a ring network having information transmission directivity, the method comprising step of:
sharing entry information indicating nodes related to the multicast communication;
broadcasting the entry information on the ring network; and
sharing, among the nodes, topology information about a positional relation on the ring network,
the steps being performed by a sending node and a receiving node which communicate by multicast on the ring network;
determining a sending direction for sending multicast information by referring to the entry information and the topology information; and
multicasting the information in the sending direction,
the steps being performed by sending node; and
discarding the information when no other node receives the information in the sending direction, the step being performed by the receiving node.

2. The method for making effective use of a bandwidth in multicast communication on a ring network according to claim 1, wherein the entry information includes an address of the sending node and an address of the receiving node.

3. The method for making effective use of a bandwidth in multicast communication on a ring network according to claim 1 or 2, wherein the topology information includes the sending direction and an address of the receiving node.

4. The method for making effective use of a bandwidth in multicast communication on a ring network according to claim 3, wherein:
in the entry information sharing step, the sending node receives the information from a sending host subordinate to the sending node; and
the sending node generates the entry information on the basis of the information.

5. The method for making effective use of a bandwidth in multicast communication on a ring network according to claim 4, wherein:
in the entry information sharing step, the receiving node receives reception request information which requests reception of the information, from a receiving host subordinate to the receiving node;
the receiving node generates a reception request command in accordance with the reception request information; and
the receiving node sends the reception request command to the sending node.

6. The method for making effective use of a bandwidth in multicast communication on a ring network according to claim 5, wherein:
in the entry information sharing step, the sending node updates the entry information in accordance with the reception request command; and
the sending node sends the updated entry information in the step of broadcasting the entry information.

7. The method for making effective use of a bandwidth in multicast communication on a ring network according to claim 6, wherein:
in the entry information sharing step, the receiving node receives, from the receiving host, leaving request information which requests a halt of the reception of the information;
the receiving node checks whether there is any other receiving host in accordance with the leaving request information;
the receiving node generates a deletion request command when there is no receiving host; and
the receiving node sends the deletion request command to the sending node.

8. The method for making effective use of a bandwidth in multicast communication on a ring network according to claim 7, wherein:
in the entry information sharing step, the sending node updates the entry information in accordance with the deletion request command; and
the sending node sends the updated entry information in the step of broadcasting the entry information.

9. The method for making effective use of a bandwidth in multicast communication on a ring network according to claim 8, wherein:
in the entry information sharing step, the sending node detects from the sending host that transmission of the information is ended;
the sending node generates a transmission end command for notifying the receiving node that the transmission of the information is ended;
the sending node sends the transmission end command to the receiving node; and
the sending node deletes the entry information in response to the end of the transmission.

10. A storage medium stored a program, which causes nodes to make effective use of a bandwidth in multicast communication on a ring network having information transmission directivity, the program instructing the node to execute:
an entry information generating step of generating entry information indicating nodes related to the multicast communication;
an entry information sharing step of sharing the entry information;
a topology information sharing step of sharing, among the nodes, topology information about a positional relation on the ring network;
a step of broadcasting the entry information on the ring network;
a step of determining a sending direction for sending multicast information by referring to the entry information and the topology information; and
a step of multicasting the information in the sending direction, the program causing a node receiving the information to discard the information when no other node receives the information in the sending direction.

11. The storage medium according to claim 10, wherein the entry information includes an address of the sending node and an address of the receiving node.

12. The storage medium according to claim 10 or 11, wherein the topology information includes the sending direction and an address of the receiving node.

13. The storage medium according to claim 12, wherein:
in the entry information generating step, the information is received from a sending host subordinate to the node; and
the entry information is generated on the basis of the information.

14. The storage medium according to claim 13, wherein:
in the entry information generating step, a reception request command is received from a receiving node which requests reception of the information; and
the entry information is updated in accordance with the reception request command.

15. The storage medium according to claim 14, wherein:
in the entry information generating step, a deletion request command is received from a receiving node which requests leaving from the multicast communication;
the entry information is updated in accordance with the deletion request command; and
the updated entry information is sent in the step of broadcasting the entry information.

16. The storage medium according to claim 15, wherein:
in the entry information generating step, it is detected from the sending host that transmission of the information is ended;
a transmission end command is generated to notify the receiving node that the transmission of the information is ended;
the transmission end command is sent to the receiving node; and
the entry information is deleted in response to the end of the transmission.

17. A storage medium stored a program, which causes nodes to make effective use of a bandwidth in multicast communication on a ring network having information transmission directivity, the program controlling the node to execute:
a step of receiving entry information indicating nodes related to the multicast communication;
an entry information sharing step of sharing the entry information;
a topology information sharing step of sharing, among the nodes, topology information about a positional relation on the ring network;
a step of referring to a sending direction in which information is sent by multicast;
a step of judging the sending direction;
a step of forwarding the information in the sending direction when any node in the sending direction receives the information; and
a step of discarding the information when no other node receives the information in the sending direction.

18. The storage medium according to claim 17, wherein:
in the entry information sharing step, reception request information which requests reception of the information is received from a receiving host subordinate to a receiving node;
a reception request command is generated in accordance with the reception request information; and
the reception request command is sent to the sending node.

19. The storage medium according to claim 18, wherein:
in the entry information sharing step, leaving request information that requests a halt of the reception of the information is received from the receiving host;
whether there is any other receiving host is detected in accordance with the leaving request information;
when there is no receiving host, a deletion request command is generated; and
the deletion request command is sent to the sending node.

20. A sending node which performs multicast communication on a ring network having information transmission directivity, comprising:
entry information generating unit that generates entry information indicating nodes related to the multicast communication;
entry information sharing unit that allows sharing of the entry information;
topology information sharing unit that allows sharing, among nodes, of topology information about a positional relation on the ring network;
entry information sending unit that broadcasts the entry information on the ring network;
sending direction determining unit that determines a sending direction for sending multicast information by referring to the entry information and the topology information; and
information sending unit that multicasts the information in the sending direction,
wherein the sending node causes a receiving node which receives the information to discard the information when no other node in the sending direction receives the information.

21. The sending node according to claim 20, wherein the entry information includes an address of the sending node and an address of the receiving node.

22. The sending node according to claim 20 or 21, wherein the topology information includes the sending direction and an address of the receiving node.

23. The sending node according to claim 22, wherein:
in the entry information generating unit receives the information from a sending host subordinate to the sending node; and
the entry information is generated on the basis of the information.

24. The sending node in multicast communication on a ring network according to claim 22, wherein the entry information generating unit updates the entry information in accordance with a reception request command from a receiving node which requests reception of the information.

25. The sending node in multicast communication on a ring network according to claim 24, wherein the entry information generating unit updates the entry information in accordance with a deletion request command from a receiving node which requests leaving from the multicast communication.

26. The sending node in multicast communication on a ring network according to claim 25, wherein:
the entry information generating unit detects from the sending host that transmission of the information is ended;
a transmission end command is generated to notify the receiving node that the transmission of the information is ended; and
the entry information is deleted in response to the end of the transmission.

27. A receiving node for performing multicast communication on a ring network having information transmission directivity, comprising:
entry information receiving unit for receiving entry information indicating nodes related to the multicast communication;
entry information sharing unit for sharing the entry information;
topology information sharing unit for sharing, among the nodes, topology information about a positional relation on the ring network;
sending direction referring unit for referring to a sending direction in which information is sent by multicast;
sending unit for sending the information in the sending direction; and
information discarding unit for discarding the information when no node in the sending direction receives the information.

28. The receiving node in multicast communication on a ring network according to claim 27, wherein:
the entry information sharing unit receives reception request information which requests reception of the information, from a receiving host subordinate to the receiving node;
the entry information sharing unit generates a reception request command in accordance with the reception request information; and
the sending unit sends the reception request command to a sending node.

29. The receiving node in multicast communication on a ring network according to claim 28, wherein:
the entry information sharing unit receives, from the receiving host, leaving request information which requests a halt of the reception of the information;
the entry information sharing unit detects whether there is any other receiving host in accordance with the leaving request information;
the entry information sharing unit generates a deletion request command when there is no receiving host; and
the sending unit sends the deletion request command to the sending node.
